(19) United States
(12) Patent Application Publication
(10) Pub. No.: US 2020/0281160 A1
(43) Pub. Date: Sep. 10, 2020

(54) Edible Dog Toy with Internal Treat Cavity

(71) Applicant: DELCA CORPORATION, Mission Viejo, CA (US)

(72) Inventor: Sabine S Crane, San Clemente, CA (US)

(21) Appl. No.: 16/747,207

(22) Filed: Jan. 20, 2020

Related U.S. Application Data
(60) Provisional application No. 62/794,417, filed on Jan. 18, 2019.

(51) Int. Cl. A01K 15/02; A01K 5/02

(52) U.S. Cl. CPC A01K 15/026; A01K 5/0241

(57) ABSTRACT

A dog toy has a cavity for holding a dog treat or another toy and is in the form of a ball and is edible. Several apertures allow a dog to see and smell the contents of the inner cavity and provide motivation for the dog to try to get at the cavity's contents. The upper and lower halves are screwed or snapped together, enabling the dog toy to be opened by a human in order to place a toy or treat in the inner cavity. The dog toy is made with a formula that results in it being sufficiently hard and durable that it will take time and effort for a dog to break through to get at the contents. The toy will therefore help clean the dog's teeth and gums as the dog chews at it.

### RELATED APPLICATION

This application claims priority to U.S. Provisional Patent Application Ser. No. 62/794,417 for an “Edible Dog Toy with Internal Treat Cavity,” filed Jan. 18, 2019, and currently co-pending, the entirety of which is incorporated herein by reference.

### FIELD OF THE INVENTION

The present invention pertains generally to toys for use in entertaining pets. More particularly, the present invention pertains to an edible dog toy with an internal cavity. The Present invention is particularly, but not exclusively, useful as an edible dog toy with a dog treat inside.

### BACKGROUND OF THE INVENTION

Humans and dogs have associated with each other for thousands of years. Some remains of what are thought to be domesticated dogs date back to the Paleolithic era. Today, dogs may be kept to guard livestock, hunt, or perform other types of labor, but it is also common for dogs to be kept as pets.

Dog food and dog toys have become massive industries, with sales in the tens of billions of dollars annually. Over the past two centuries, dog food has taken the forms of kibbles, canned food, and treats.

### SUMMARY OF THE INVENTION

Disclosed is a dog toy having a cavity for holding a dog treat or another toy. In a preferred embodiment, the dog toy is in the form of a ball and is edible. Several apertures allow a dog to see and smell the contents of the inner cavity and provide motivation for the dog to try to get at the cavity's contents.

The dog toy is made with a formula that results in it being sufficiently hard and durable that it will take time and effort for a dog to break through to get at the contents. The toy will therefore help clean the dog's teeth and gums as the dog chews at it. A preferred embodiment of the formula comprises wheat and meat and bone meal. Another preferred embodiment of the formula comprises rawhide. Another preferred embodiment of the formula comprises corn starch and meat.

Preferred embodiments of the dog toy comprise an upper half and a lower half that are screwed or snapped together, enabling the dog toy to be opened by a human in order to place a toy or treat in the inner cavity.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an edible dog toy with an internal treat cavity;

FIG. 2 is a top plan view of an edible dog toy with an internal treat cavity;

FIG. 3 is an elevation view of an edible dog toy with an internal treat cavity;

FIG. 4 is a perspective view of a lower half of an edible dog toy with an internal treat cavity;

FIG. 5 is a top plan view of a lower half of an edible dog toy with an internal treat cavity;

FIG. 6 is a perspective view of an upper half of an edible dog toy with an internal treat cavity; and

FIG. 7 is a bottom plan view of an upper half of an edible dog toy with an internal treat cavity.

### DETAILED DESCRIPTION

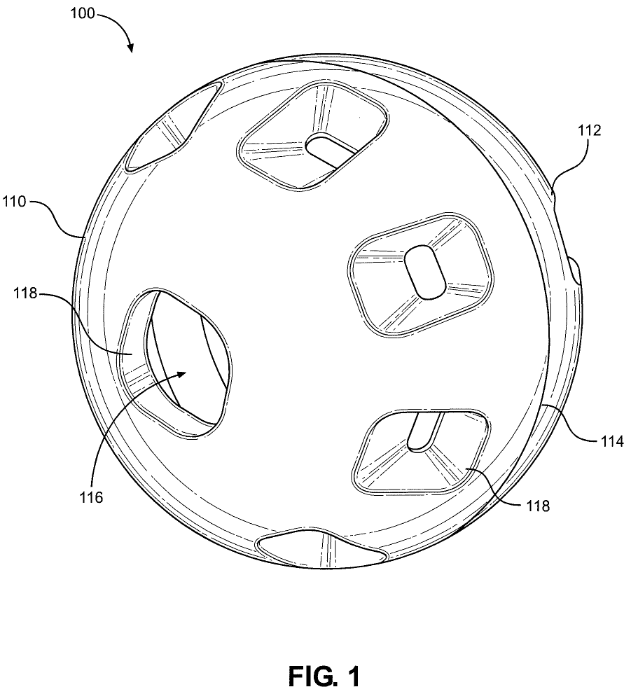

Referring initially to FIG. 1, a perspective view of a preferred embodiment of an edible dog toy with an internal treat cavity (hereinafter “dog toy”) is shown and generally designated 100. Dog toy 100 comprises an upper half 110 and a lower half 112 that are removably joined together at junction 114. In a preferred embodiment, upper half 110 and lower half 112 are hemispherical, resulting in a spherical dog toy 100 when joined. The separability of the two halves 110 and 112 allows a toy or treat to be placed inside an internal cavity 116 of the dog toy 100. Preferred embodiments comprise multiple apertures 118 on each of the two halves 110 and 112 of the dog toy 100, allowing the contents of the internal cavity 116 to be seen and smelled.

While a preferred embodiment of Dog Toy 100 is depicted as spherical in shape, it is to be appreciated that other shapes may be used without departing from the spirit of the present invention. The specific shape of the Dog Toy 100 is virtually limitless, and other shapes could include, but not be limited to geometric shapes, such as conical, tubular, rectangular, cubical, or other more unique shapes such as animal shapes, shoe shapes, hamburger shapes, bone shapes, etc. In such instances, it is possible that upper half 110 and lower half 112 are not symmetrical in shape, but nevertheless joint at a junction 114 formed between the two halves 110 and 112.

Dog toy 100 is made of a material sufficiently durable that a dog will not immediately be able to chew through it. Moreover, in preferred embodiments, dog toy 100 is made of a material edible and digestible by a dog, such as a material comprising corn starch and meat.

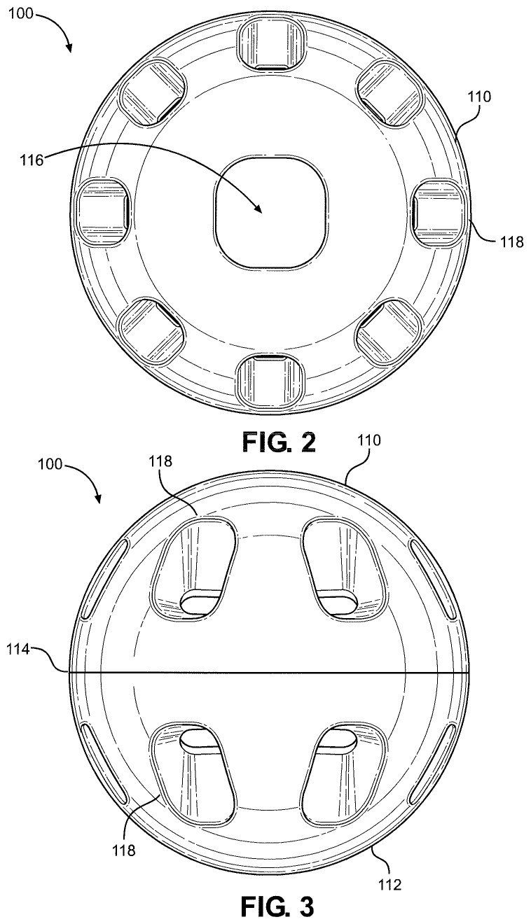

Referring now to FIG. 2, a top view of dog toy 100 is illustrated, presenting an exemplary layout of apertures 118 on upper half 110 of dog toy 100. In preferred embodiments, lower half 112 of dog toy 100 appears substantially similar to upper half 110 when the two halves 110 and 112 are joined together.

Referring now to FIG. 3, a front view of dog toy 100 is illustrated, showing the presence of multiple apertures 118 on both upper half 110 and lower half 112 of dog toy 100. In preferred embodiments, the assembled dog toy 100 appears symmetrical above and below junction 114, as upper half 110 and lower half 112 of dog toy 100 have a similar appearance and a similar layout of apertures 118. As indicated above, however, upper half 110 and lower half 112 need not be symmetrical, and can depict a wide variety of shapes while maintaining the presence of apertures 118, and are formed to create a junction 114 when the upper half 110 and lower half are placed together.

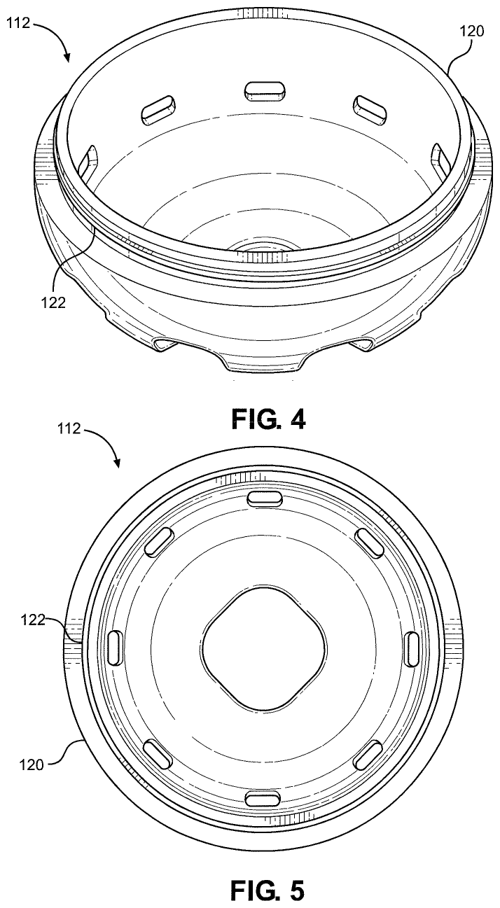

Referring now to FIG. 4, a perspective view of lower half 112 of dog toy 100 is illustrated. Lower half 112 of dog toy 100 is bowl-shaped, or in the form of a hollowed-out hemisphere. The edge of a bowl-shape, which would be a great circle of the sphere formed by the combination of two hemispheres, is referred to herein as an “orthodromic perimeter” for convenience. In preferred embodiments, around the orthodromic perimeter 120 of lower half 112 is an extruded member 122 configured to be received by upper half 110 of dog toy 100 in order to assemble dog toy 100. In a preferred embodiment, extruded member 122 is threaded, so that lower half 112 is screwed into upper half 110 to join the two halves together. In another preferred embodiment, extruded member 122 is configured to snap into upper half 110 in order to join the two halves together. For instance, extruded member 122 may be received into a correspondingly sized groove, notch or slot receiver 128.

Alternative embodiments of the present invention could include upper half 110 and lower half 112 being formed with a snug-fitting dimension such that when the two halves are forced together, the orthodromic perimeter 120 of the upper half 110 is closely received in the orthodromic perimeter 124 of lower half 112 such that seam 114 is formed by pressure and friction exerted between the two halves.

Referring now to FIG. 5, a top plan view of lower half 112 of dog toy 100 is illustrated. Orthodromic perimeter 120 is circular in shape and corresponds to the portion of lower half 112 at junction 114 of dog toy 100 when dog toy 100 is in its assembled configuration.

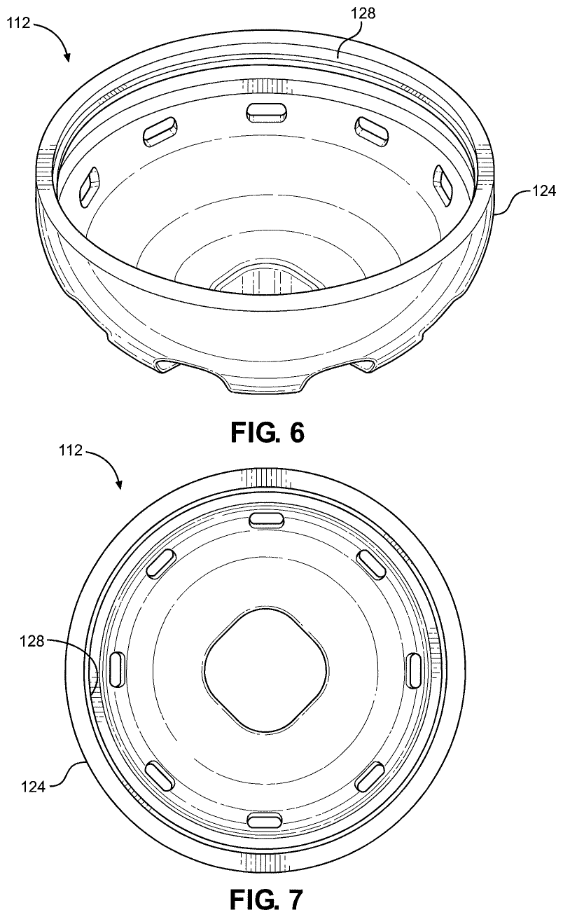

Referring now to FIG. 6, a perspective view of upper half 110 of dog toy 100 is illustrated. Like lower half 112, upper half 110 of dog toy 100 is hemispherical or bowl-shaped. Inside orthodromic perimeter 126 of upper half 110 of dog toy 100 is a receiver 128 configured to receive extruded member 122. In embodiments in which extruded member 122 is threaded, receiver 128 is also threaded so that lower half 112 screws into upper half 110 to form a spherical shape in the assembled configuration of dog toy 100. As mentioned previously, extruded member 122 and receiver 128 snap together in another embodiment in order to place dog toy 100 into its assembled configuration.

Referring now to FIG. 7, a bottom plan view of upper half 110 of dog toy 100 is illustrated. Like orthodromic perimeter 120, orthodromic perimeter 124 is circular in shape, and corresponds to the portion of upper half 110 at junction 114 of dog toy 100 when dog toy 100 is in its assembled configuration.

While there have been shown what are presently considered to be preferred embodiments of the present invention, it will be apparent to those skilled in the art that various changes and modifications can be made herein without departing from the scope and spirit of the invention.

What is claimed is:

1. An edible dog toy, comprising:
a body comprising:
an upper half;
a lower half removably joined to the upper half;
an internal cavity; and
a plurality of apertures allowing the contents of the internal cavity to be viewed,
wherein the body is made of material edible and digestible by a dog.

2. The edible dog toy as recited in claim 1, wherein the body comprises corn starch and meat.

3. The edible dog toy as recited in claim 1, wherein the body comprises a spherical shape.

4. The edible dog toy as recited in claim 3, wherein the upper half and the lower half appear symmetrical when joined.

5. The edible dog toy as recited in claim 4, wherein the lower half has a threaded extruded member configured to be received by a threaded receiver of the upper half in order to join the lower half to the upper half.

6. The edible dog toy as recited in claim 4, wherein the lower half has an extruded member configured to snap into a receiver of the upper half in order to join the lower half to the upper half.

7. The edible dog toy as recited in claim 4, wherein a first half of the apertures of the plurality of apertures is arranged according a predetermined layout on the upper half, and a second half of the apertures of the plurality of apertures is arranged according to the same predetermined layout on the lower half.

8. An edible dog toy, comprising:
an internal cavity;
a spherical body surrounding the internal cavity;
a plurality of apertures in the spherical body; and
an object located in the internal cavity,
wherein the spherical body is made of a material edible and digestible by a dog, and
wherein the object located in the internal cavity is of interest to a dog.

9. The edible dog toy as recited in claim 8, wherein the spherical body comprises corn starch and meat.

10. The edible dog toy as recited in claim 8, wherein the object located in the internal cavity is selected from the group consisting of a dog treat and a dog toy.

11. The edible dog toy as recited in claim 8, wherein the object located in the internal cavity is a dog treat.

12. The edible dog toy as recited in claim 8, wherein the object located in the internal cavity is a dog toy.

13. The edible dog toy as recited in claim 8, wherein the body comprises two separable halves.

14. An edible dog toy, comprising:
a spherical body, comprising:
a bowl-shaped upper half having a first set of apertures;
a bowl-shaped lower half having a second set of apertures; and
an internal cavity,
wherein the lower half is removably joined to the upper half.

15. The edible dog toy as recited in claim 14, wherein the first set of apertures is laid out according to the same pattern as the second set of apertures.

16. The edible dog toy as recited in claim 14, wherein the spherical body comprises corn starch and meat.

17. The edible dog toy as recited in claim 14, wherein the lower half has a threaded extruded member configured to be received by a threaded receiver of the upper half in order to join the lower half to the upper half.

18. The edible dog toy as recited in claim 14, wherein the lower half has an extruded member configured to snap into a receiver of the upper half in order to join the lower half to the upper half.

19. The edible dog toy as recited in claim 14, further comprising a dog treat in the internal cavity.

20. The edible dog toy as recited in claim 14, further comprising a dog toy in the internal cavity.
